(19) United States
(12) Patent Application Publication
(10) Pub. No.: US 2009/0284872 A1
(43) Pub. Date: Nov. 19, 2009

(54) MAGNETIC HEAD SUPPORT AND MAGNETIC DISK DEVICE

(75) Inventors: Masaharu HIDA, Kawasaki (JP); Shigeyoshi UMEMIYA, Kawasaki (JP); Masao KONDO, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/511,401

(22) Filed: Jul. 29, 2009

Related U.S. Application Data
(63) Continuation of application No. PCT/JP07/55376, filed on Mar. 16, 2007.

(51) Int. Cl. G11B 5/48; G11B 5/56

(52) U.S. Cl. 360/294.4; G9B/5.147

(57) ABSTRACT

A magnetic head support includes a slider on which a magnetic head is mounted; a suspension that supports the slider; and a pair of piezoelectric actuators that are arranged on sides of the slider other than a side on which the magnetic head is mounted so as to be opposed to each other. The piezoelectric actuators are fixed to the suspension and the slider, and cause the slider to undergo a rotational displacement.

### CROSS-REFERENCE TO RELATED APPLICATION(S)

This application is a continuation of PCT international application Ser. No. PCT/JP2007/055376 filed on Mar. 16, 2007 which designates the United States, the entire contents of which are incorporated herein by reference.

### FIELD

The embodiments discussed herein are directed to a magnetic disk device.

### BACKGROUND

Technical improvements in the magnetic disk, a magnetic head, signal processing, and the like are increasing the storage density of magnetic disks in magnetic disk devices (hard disk drives (HDDs)) at a very strong growth rate. With the increase in storage density, a track pitch of the magnetic disk becomes narrower. Thus, it is preferable to position the magnetic head to a target track with high accuracy.

Positioning of the magnetic head is controlled by sliding a carriage arm, mounting thereon the magnetic head, around an arm axis on the magnetic disk. In such an operation mode (a seek operation mode), to bring the magnetic head to a next target track, a feedback control in accordance with a predetermined speed pattern is performed.

With the speeding up of the seek operation, it is becoming difficult to achieve high-accuracy positioning of the magnetic head with the control by an arm mechanism only. To achieve high-accuracy positioning of the magnetic head, there has been developed a technique that a mechanism for causing the magnetic head to undergo a small displacement is additionally provided on a tip of the arm mechanism. That is “a dual actuator” equipped with a second actuator (a micro-displacement actuator) for causing the magnetic head to undergo a small displacement in addition to a first actuator for driving the carriage arm. Such a mechanism is especially effective because it is possible to correct a thermal misalignment between disks.

The micro-displacement actuator causes the tip of the arm mechanism to fluctuate at a high speed. Therefore, it is preferable to avoid such a situation that a structure resonant frequency of the arm mechanism (for example, a suspension included in the arm mechanism has a resonant frequency of around 10 KHz) is affected by the fluctuation of the tip of the arm mechanism thereby interfering with the smooth seek operation. To cope with such a problem, there has been developed a mechanism capable of causing a magnetic head to undergo a small displacement while suppressing the effect on such an arm mechanism (for example, see Japanese Laid-open Patent Publication No. 2003-284362 and Japanese Laid-open Patent Publication No. 2001-84723).

In the conventional technologies disclosed in Japanese Laid-open Patent Publication No. 2003-284362 and Japanese Laid-open Patent Publication No. 2001-84723, as the micro-displacement actuator, a pair of piezoelectric actuators is provided between a suspension and a slider. The piezoelectric actuators cause the slider to undergo a rotational displacement, and thereby causing a magnetic head to undergo a small displacement while suppressing the effect on an arm mechanism.

However, in a magnetic disk device disclosed in Japanese Laid-open Patent Publication No. 2003-284362 and Japanese Laid-open Patent Publication No. 2001-84723, the micro-displacement actuator is arranged in the space between the suspension and the slider, so that a portion corresponding to the slider, i.e., a tip of the suspension increases in thickness. Generally, in a magnetic disk device, a stack of a plurality of disks is arranged. Therefore, if the above configuration is applied to each of the disks, the thickness of the entire magnetic disk device is considerably increased, or the number of magnetic disks is limited.

Furthermore, the slider is arranged at a position distant from the suspension, so that the slider is prone to rolling. Thus, there is a high possibility that the rolling has an adverse affect on a seek operation of the arm mechanism as a disturbance.

### SUMMARY

According to an aspect of the invention, a magnetic head support includes a slider on which a magnetic head is mounted; a suspension that supports the slider; and a pair of piezoelectric actuators that are arranged on sides of the slider other than a side on which the magnetic head is mounted so as to be opposed to each other. The piezoelectric actuators are fixed to the suspension and the slider, and cause the slider to undergo a rotational displacement.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view illustrating the inside of a magnetic disk device according to a first embodiment of the present invention;

FIG. 2 is a diagram illustrating a schematic configuration of a circuit that controls the magnetic disk device according to the first embodiment of the present invention;

FIGS. 3A and 3B are diagrams illustrating a magnetic head support according to the first embodiment of the present invention;

FIG. 4 is a diagram illustrating how to fix piezoelectric actuators;

FIG. 5 is a diagram illustrating a detailed structure of each of the piezoelectric actuators;

FIGS. 6A and 6B are diagrams illustrating an amount of displacement of a slider obtained by a simulation 1;

FIGS. 7A and 7B are diagrams illustrating an amount of displacement of the slider obtained by a simulation 2;

FIGS. 8A and 8B are diagrams illustrating an amount of displacement of the slider obtained by a simulation 3;

FIG. 9 is a graph illustrating an amount of displacement of the slider with changes in Young's modulus of an elastic member;

FIG. 10 is a diagram illustrating an example of an actuator having a length shorter than that of a long side of the slider; and

FIG. 11 is a diagram illustrating an example of an actuator whose end to be fixed to a suspension is provided at a position away from the slider.

### DESCRIPTION OF EMBODIMENTS

Preferred embodiments of the present invention will be explained with reference to accompanying drawings. The embodiments are illustrative examples, and the present invention is not limited to configurations used in the embodiments.

### [a] First Embodiment

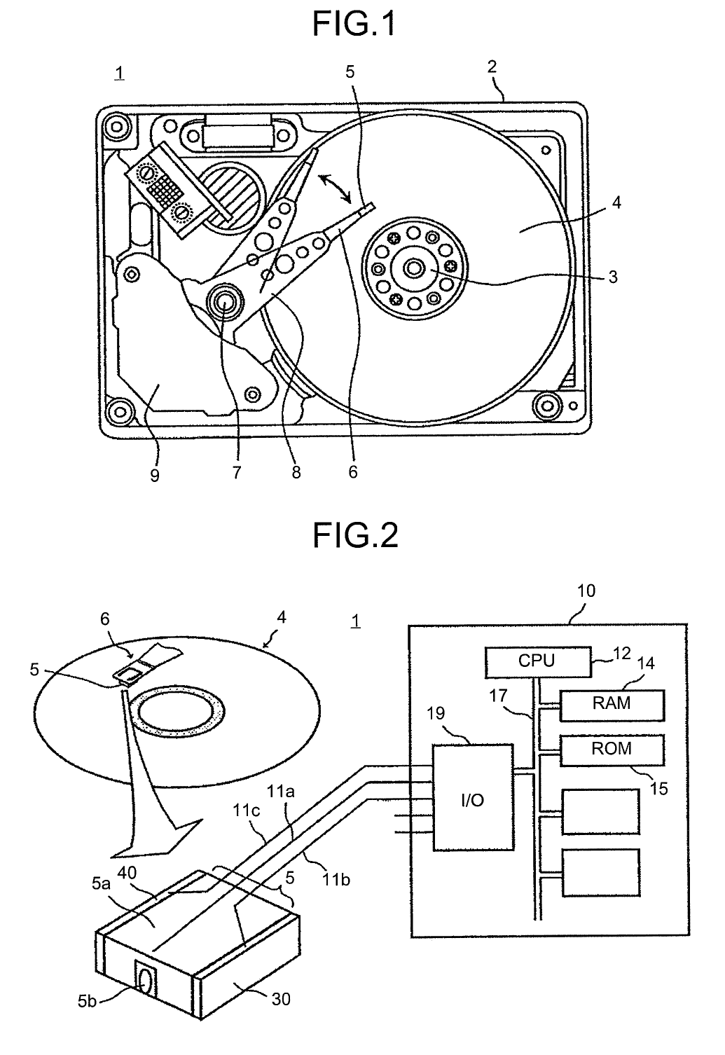

An example of a magnetic disk device equipped with a magnetic head support according to the present invention is explained below with reference to FIGS. 1 and 2. FIG. 1 is a plan view illustrating the inside of a magnetic disk device according to a first embodiment of the present invention. FIG. 2 is a diagram illustrating a schematic configuration of a circuit that controls the magnetic disk device according to the first embodiment of the present invention.

A magnetic disk device 1 illustrated in FIG. 1 is an HDD, and includes a housing 2 as an exterior package. Inside the housing 2, there are provided a magnetic disk 4, a slider 5, a suspension 6, a carriage arm 8, and an electromagnetic actuator 9. The magnetic disk 4 is attached to a rotating shaft 3, and rotates around the rotating shaft 3. A magnetic head is mounted on the slider 5. The slider 5 writes information on the magnetic disk 4, and reads information from the magnetic disk 4. The suspension 6 holds the slider 5. The suspension 6 is fixed to the carriage arm 8. The carriage arm 8 moves around an arm axis 7 along the surface of the magnetic disk 4. The electromagnetic actuator 9 drives the carriage arm 8. A cover (not illustrated) is attached to the housing 2, and the above-described components are housed in an internal space formed by the housing 2 and the cover.

As illustrated in FIG. 2, the magnetic disk device 1 further includes a control unit 10. The control unit 10 controls the operation of the magnetic disk device 1. The control unit 10 is mounted, for example, on a control board (not illustrated) provided inside the housing 2. As illustrated in FIG. 2, the control unit 10 is composed of a central processing unit (CPU) 12, a random access memory (RAM) 14, a read-only memory (ROM) 15, an input/output (I/O) circuit 19, a bus 17, and the like. In the RAM 14, data to be processed by the CPU 12 and the like are temporarily stored. In the ROM 15, a control program and the like are stored. The I/O circuit 19 inputs/outputs a signal to the outside. A signal is transmitted among these circuits through the bus 17.

Furthermore, as illustrated in FIG. 2, the slider 5 mounted on the suspension 6 includes a magnetic head 5b. The magnetic head 5b is formed on a slider main body 5a. The magnetic head 5b is connected, for example, to the I/O circuit 19 in the control unit 10 by a wire 11a, and performs recording information on the magnetic disk 4 (a write operation) and reproducing information stored in the magnetic disk 4 (a read operation). When the write operation and the read operation are performed, the electromagnetic actuator 9 drives the carriage arm 8 to move the magnetic head 5b to a desired track on the magnetic disk 4.

In the write operation, the magnetic head 5b receives an electrical signal (an electrical write signal) from the control unit 10, and applies a magnetic field depending on the write signal to each of micro regions of the magnetic disk 4. Then, the magnetic head 5b writes information carried by the write signal (while displacing the information in a magnetization direction of each of the micro regions). In the read operation, the magnetic head 5b retrieves information written on each of the micro regions as an electrical signal depending on magnetization of each of the micro regions (an electrical read signal). Then, the magnetic head 5b transmits the retrieved read signal to the control unit 10.

Furthermore, as illustrated in FIG. 2, piezoelectric actuators 30 and 40 for causing the slider 5 to undergo a rotational displacement are arranged on both sides of the block-like slider 5. The piezoelectric actuators 30 and 40 are connected to the control unit 10 via wires 11b and 11c, respectively. Based on a control signal from the control unit 10, each of the piezoelectric actuators 30 and 40 deforms the shape thereby causing the slider 5 to undergo a rotational displacement. Details of the piezoelectric actuators 30 and 40 will be described later.

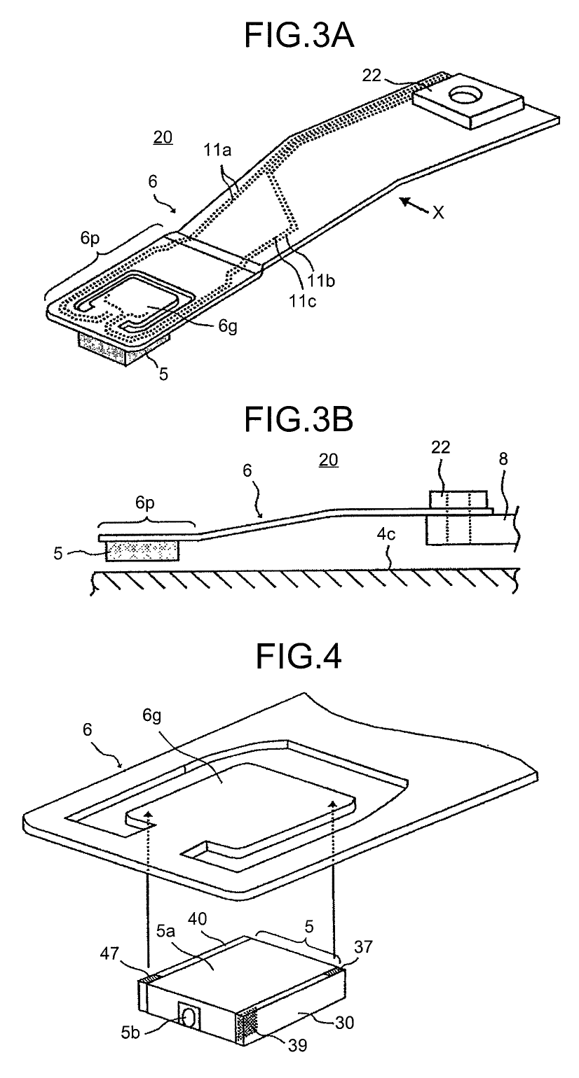

An example of the magnetic head support according to the present invention is explained below with reference to FIGS. 3A and 3B. The magnetic head support is also referred to as “a head gimbal assembly (HGA)”. FIGS. 3A and 3B are diagrams illustrating the magnetic head support according to the first embodiment of the present invention. FIG. 3A is a perspective view of the magnetic head support, and FIG. 3B is a side view of the magnetic head support (viewed from a direction X illustrated in FIG. 3A).

As illustrated in FIG. 3A, a magnetic head support 20 generally means a structure in which a base plate 22, the slider 5, and the like are attached to the suspension 6. However, the structure before the base plate 22 and the slider 5 are attached to the suspension 6, i.e., only the suspension 6 is sometimes referred to as the magnetic head support 20. Furthermore, a structure in which either the base plate 22 or the slider 5 is attached to the suspension 6 may be referred to as the magnetic head support 20. In this example, the suspension 6 is a plate-like member made of stainless steel, for example, 20 micrometers (μm) thick. As illustrated in FIG. 3B, the base plate 22 is joined to one end of the suspension 6 on the side of the carriage arm 8, and the slider 5 is attached to a tip portion 6p on the other end of the suspension 6. Specifically, the slider 5 on which the magnetic head 5b is formed is arranged to be opposed to a surface 4c of the magnetic disk 4, and fixed to a gimbal portion 6g provided at the tip portion 6p of the suspension 6.

Furthermore, as illustrated in FIG. 3A, the wire 11a formed on the suspension 6 is electrically connected to an electrode (not illustrated) of the magnetic head 5b. Similarly, the wires 11b and 11c formed on the suspension 6 are electrically connected to respective electrodes (not illustrated) of the piezoelectric actuators 30 and 40. The wires 11a, 11b, and 11c are all electrically connected to the control unit 10, and each of the magnetic head 5b and the piezoelectric actuators 30 and 40 is controlled by a control signal from the control unit 10.

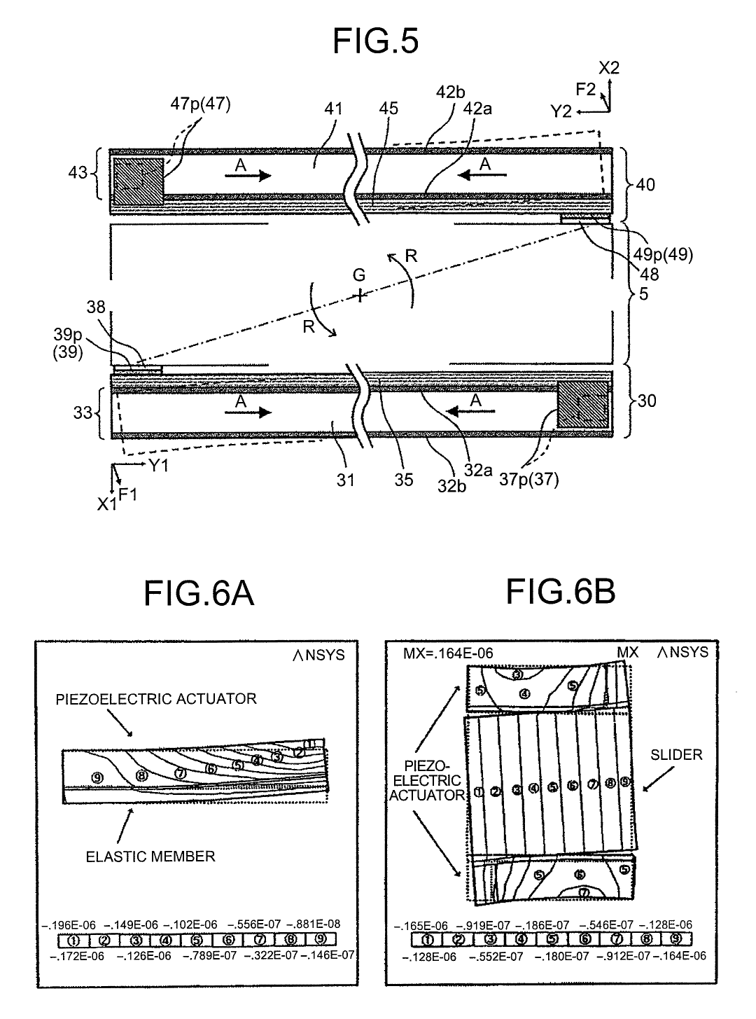

Subsequently, an example of the piezoelectric actuators according to the present invention is explained below with reference to FIGS. 4 and 5. FIG. 4 is a diagram illustrating how to fix the piezoelectric actuators. FIG. 5 is a diagram illustrating a detailed structure of each of the piezoelectric actuators.

As illustrated in FIG. 4, the piezoelectric actuator 30 is arranged on a side of the slider 5 (more specifically, on one of sides of the slider 5 other than the side on which the magnetic head 5b is mounted), and only one end 39 of the piezoelectric actuator 30 is bonded to the slider 5 with an adhesive agent. In addition, the piezoelectric actuator 30 is arranged on one of the sides of the slider 5 other than the side opposed to the suspension 6. As the adhesive agent, for example, resin adhesive can be used. On the other hand, the other end 37 of the piezoelectric actuator 30 is fixed on the underside (the side opposed to the magnetic disk device) of the gimbal portion 6g of the suspension 6. In the same manner as the end 39, the end 37 can be bonded to the underside of the gimbal portion 6g of the suspension 6, for example, with resin adhesive.

The piezoelectric actuator 40 is arranged on the opposite side to the piezoelectric actuator 30 across the slider 5 (more specifically, on one of the sides of the slider 5 other than the side on which the magnetic head 5b is mounted). In addition, the piezoelectric actuator 40 is arranged on one of the sides of the slider 5 other than the side opposed to the suspension 6 in the same manner as the piezoelectric actuator 30. In this manner, the piezoelectric actuators 30 and 40 are arranged on the sides of the slider 5 to be opposed to each other across the slider 5. The piezoelectric actuator 40 is fixed to the slider 5 and the suspension 6 in the same manner as the piezoelectric actuator 30. Namely, only one end 49 (not illustrated) of the piezoelectric actuator 40 is bonded to the side of the slider 5, for example, with resin adhesive, and the other end 47 is fixed on the underside (the side opposed to the magnetic disk device) of the gimbal portion 6g of the suspension 6.

FIG. 5 is an overhead view of the slider 5 and the piezoelectric actuators 30 and 40. As illustrated in FIG. 5, the piezoelectric actuator 30 has a configuration that an elastic member 35 having a long side is attached to a piezoelectric device 33 along the long side. The piezoelectric device 33 has a configuration that a pair of electrodes 32a and 32b are provided on both sides of a piezoelectric material 31 so as to sandwich the piezoelectric material 31 between the electrodes 32a and 32b. On one end of the piezoelectric actuator 30, a connection pad 37p for the fixation to the suspension 6 is provided. The connection pad 37p can be provided on only a portion of the piezoelectric material 31 as indicated by a dotted line in FIG. 5; however, for enhancing the fixation effect, the size of the connection pad 37p is preferably as large as possible as indicated by a solid line. Furthermore, on the other end of the piezoelectric actuator 30, a connection pad 39p for the fixation to the slider 5 is provided.

As for the piezoelectric actuator 40, as illustrated in FIG. 5, the piezoelectric actuator 40 has the same configuration as the piezoelectric actuator 30. The piezoelectric actuator 40 has a configuration that an elastic member 45 having a long side is attached to a piezoelectric device 43 along the long side. The piezoelectric device 43 has a configuration that a pair of electrodes 42a and 42b are provided on both sides of a piezoelectric material 41 so as to sandwich the piezoelectric material 41 between the electrodes 42a and 42b. On one end of the piezoelectric actuator 40, a connection pad 47p for the fixation to the suspension 6 is provided. The connection pad 47p can be provided on only a portion of the piezoelectric material 41 as indicated by a dotted line in FIG. 5; however, for enhancing the fixation effect, the size of the connection pad 47p is preferably as large as possible as indicated by a solid line. Furthermore, on the other end of the piezoelectric actuator 40, a connection pad 49p for the fixation to the slider 5 is provided.

Adhesive agents 38 and 48, such as resin adhesive, are used for the fixation of the piezoelectric actuators 30 and 40 to the slider 5, respectively. The connection pads 39p and 49p are preferably symmetrical about the gravity of the slider 5. In this case, the piezoelectric actuators 30 and 40 are fixed to the slider 5 so as to be symmetrical about a gravity G of the slider 5.

Furthermore, the piezoelectric material 31 composing the piezoelectric device 33 and the piezoelectric material 41 composing the piezoelectric device 43 can be, for example, a stack of a plurality of active layers (layers each composed of a piezoelectric body and a pair of electrodes sandwiching the piezoelectric body between them) (not illustrated). By such a configuration, even when a voltage applied to the electrodes 32a and 32b or the electrodes 42a and 42b is low, a large amount of displacement of each of the piezoelectric actuators 30 and 40 can be obtained. Alternatively, the electrodes 32a and 32b and the electrodes 42a and 42b can be arranged at positions perpendicular to the arrangements illustrated in FIG. 5 (i.e., the front and back sides of the piezoelectric materials 31 and 41 with respect to the plane of the drawing sheet) so as to sandwich the piezoelectric materials 31 and 41 between them.

When a voltage is applied to the electrodes 32a and 32b of the piezoelectric device 33, the piezoelectric material 31 starts to shrink in a direction of arrows A depending on the applied voltage. The elastic member 35 is subjected to a force (an external force) generated by the deformation of the piezoelectric device 33, and stress is generated inside the elastic member 35. Then, stress in a direction opposite to the direction of arrows A is generated in the elastic member 35. By the action of these forces, a force F1 in a direction between an X1 direction and a Y1 direction is applied to the end 39 of the piezoelectric actuator 30. As the other end 37 of the piezoelectric actuator 30 is fixed to the suspension 6, the end 39 is displaced in the direction between the X1 direction and the Y1 direction as indicated in a dotted line by the force F1.

Similarly, when a voltage is applied to the electrodes 42a and 42b of the piezoelectric device 43, the piezoelectric material 41 starts to shrink in a direction of arrows A depending on the applied voltage. The elastic member 45 is subjected to a force (an external force) generated by the deformation of the piezoelectric device 43, and stress is generated inside the elastic member 45. Then, stress in a direction opposite to the direction of arrows A is generated in the elastic member 45. By the action of these forces, a force F2 in a direction between an X2 direction and a Y2 direction is applied to the end 49 of the piezoelectric actuator 40. As the other end 47 of the piezoelectric actuator 40 is fixed to the suspension 6, the end 49 is displaced in the direction between the X2 direction and the Y2 direction as indicated in a dotted line by the force F2.

In this manner, the ends 37 and 47 of the piezoelectric actuators 30 and 40 are fixed to the suspension 6, so that the positions of the ends 37 and 47 are not changed. In this state, the piezoelectric actuators 30 and 40 are bent in the directions of the dotted lines, and the forces F1 and F2 are applied to the slider 5, and thus the slider 5 undergoes a rotational displacement in a direction R about the gravity G. At this time, as the slider 5 undergoes the rotational displacement about the gravity G, the rotational displacement causes little or no change in position of the gravity G of the slider 5. Although the center of rotation may not strictly coincide with the gravity G of the slider 5 due to variations in characteristics of the piezoelectric actuators 30 and 40 or the like, by the use of a pair of the piezoelectric actuators, the change in position of the gravity G can be reduced. Therefore, it is possible to prevent the rotational displacement from adversely affecting on the seek operation of the arm mechanism as a disturbance by the action of excitation. Although it is enough that the forces F1 and F2 can cause the slider 5 to rotate about the gravity G, to reduce the change in position of the gravity G of the slider 5, it is preferable that the force F1 and the force F2 always act in opposite directions to each other and also have the same magnitude.

Furthermore, for effective transmission of the forces for causing the slider 5 to rotate from the piezoelectric actuators 30 and 40 to the slider 5, the elastic member 35 is preferably arranged closer to the slider 5 than the piezoelectric device 33 is.

Subsequently, when the piezoelectric actuators 30 and 40 are actually mounted on the slider 5, how the slider 5 is displaced is simulated. Results of the simulations are described below with reference to FIGS. 6 to 8. FIGS. 6 to 8 are diagrams illustrating an amount of displacement of the slider obtained by the simulations.

FIGS. 6A and 6B illustrate results of a simulation in which stainless used steel (SUS) is used as the elastic member.

FIG. 6A is a diagram illustrating deformation of the piezoelectric actuator in a case where SUS is used as the elastic member. FIG. 6B is a diagram illustrating deformation of the piezoelectric actuators and a displacement of the slider in a case where the piezoelectric actuators illustrated in FIG. 6A are mounted on the slider. Major conditions of the simulation are set as follows:

Size of piezoelectric device: 230×200×850 (unit: μm)

Thickness of electrode of piezoelectric device: 2.0 μm

Size of elastic member: 230×20×850 (unit: μm)

Young's modulus of elastic member: 197 GPa

Area of adhesion between piezoelectric actuator and slider: 230×100 (unit: μm)

Area of adhesion between piezoelectric actuator and suspension: 200×100 (unit: μm)

Under the above conditions, an amount of displacement of the slider is simulated. The slider is displaced as illustrated in FIG. 6B, and an amount of displacement at a point having the maximum amount of displacement is 164 nm. In FIG. 6B, “MX” is displayed in the piezoelectric actuator; however, the slider is similarly displaced, and the maximum amount of displacement of the slider is 164 nm. “An amount of displacement” is an amount of change of each point after a piezoelectric element is changed based on a state before the piezoelectric device is changed.

In FIGS. 6 to 8, a point having the maximum amount of displacement is denoted by “MX”. Furthermore, lines in the slider and the piezoelectric actuators in FIGS. 6 to 8 are lines connecting points having the same amount of displacement, and numbers (encircled numbers) put on the lines indicate an amount of displacement. That is, in FIGS. 6A, 7A, and 8A, an area of encircled number 9 is an area having the minimum amount of displacement, and an area of encircled number 1 is an area having the maximum amount of displacement. In FIGS. 6B, 7B, and 8B, an area of encircled number 5 is an area having the minimum amount of displacement; and the farther an area is located from the area of encircled number 5 to either side, the larger an amount of displacement is. Furthermore, dotted lines in FIGS. 6 to 8 indicate the positions of the slider and the piezoelectric actuators before being displaced; and solid lines indicate the positions of the slider and the piezoelectric actuators after being displaced.

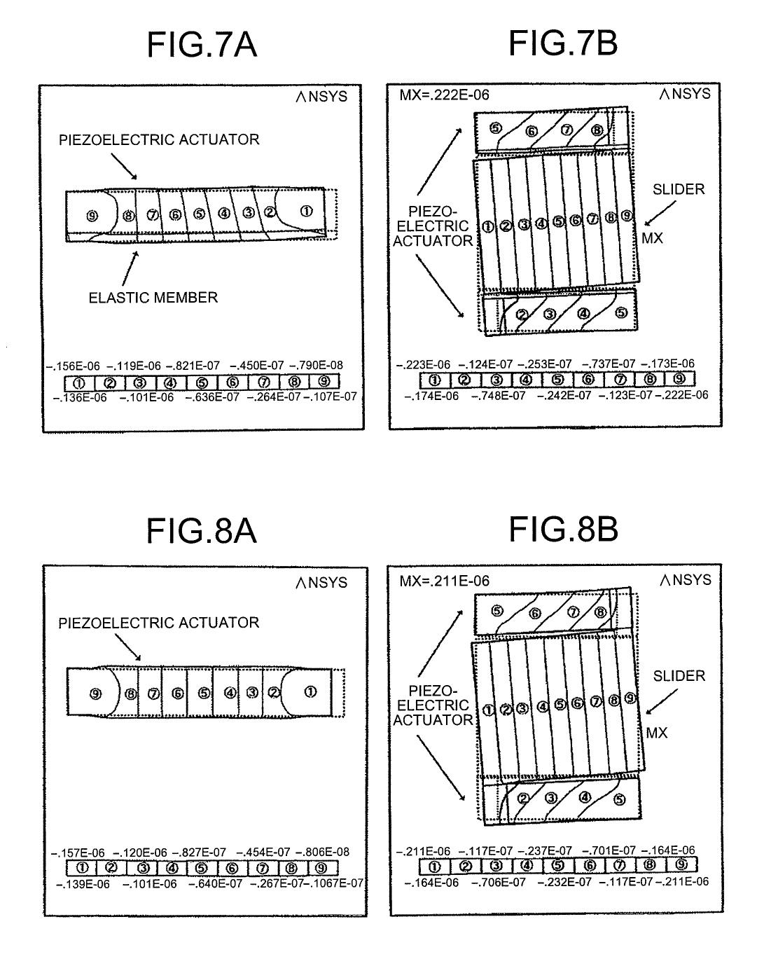

FIGS. 7A and 7B illustrate results of a simulation in which a resin material is used as the elastic member.

FIG. 7A is a diagram illustrating deformation of the piezoelectric actuator in a case where a resin material is used as the elastic member. FIG. 7B is a diagram illustrating deformation of the piezoelectric actuators and a displacement of the slider in a case where the piezoelectric actuators illustrated in FIG. 7A are mounted on the slider. Major conditions of the simulation are identical to those of the simulation illustrated in FIGS. 6A and 6B except that the Young's modulus of the elastic member is set to 2.4 GPa.

Under the above conditions, an amount of displacement of the slider is simulated. The slider is displaced as illustrated in FIG. 7B, and an amount of displacement at a point having the maximum amount of displacement is 222 nm.

FIGS. 8A and 8B illustrate results of a simulation in which the elastic member is not used. FIG. 8A is a diagram illustrating deformation of the piezoelectric actuator in a case where the elastic member is not used. FIG. 8B is a diagram illustrating deformation of the piezoelectric actuators and a displacement of the slider in a case where the piezoelectric actuators illustrated in FIG. 8A are mounted on the slider. Major conditions of the simulation are identical to those of the simulation illustrated in FIGS. 6A and 6B except that a setting for the elastic member is not made.

Under the above conditions, an amount of displacement of the slider is simulated. The slider is displaced as illustrated in FIG. 8B, and an amount of displacement at a point having the maximum amount of displacement is 211 nm.

In this manner, when the resin material having the property of shrinking in the direction of the long side of the piezoelectric actuator is used as the elastic member, a larger amount of displacement is obtained as compared with the case where the metal SUS material is used as the elastic member. Furthermore, in the comparison between with and without the elastic member, a larger amount of displacement is obtained when the elastic member is used (i.e., when the elastic member is attached to each of the piezoelectric actuators along the long side thereof).

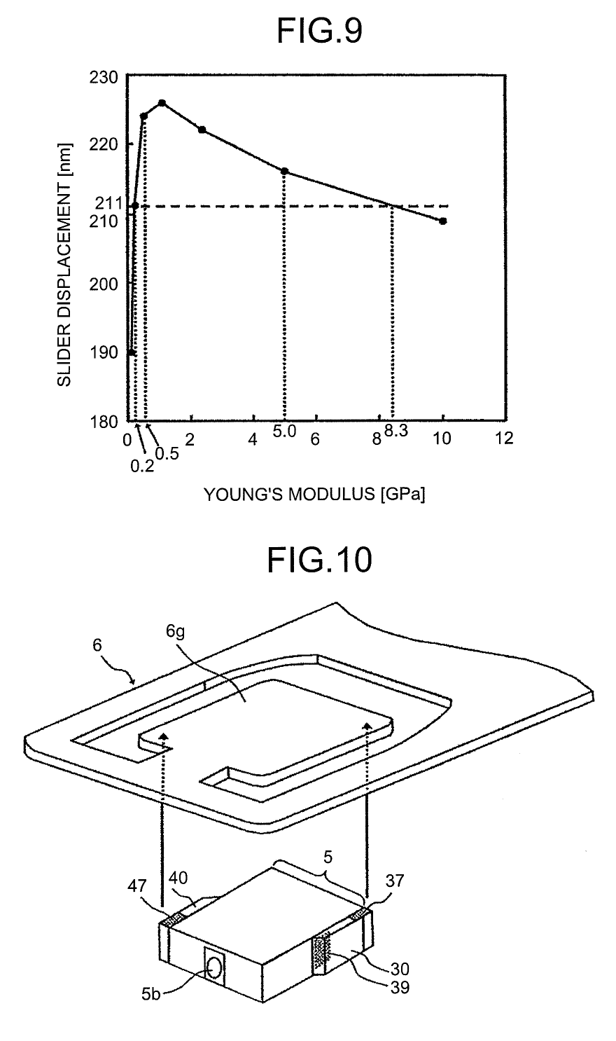

Subsequently, as a result of a simulation, an amount of displacement of the slider with changes in Young's modulus of the elastic member is described. FIG. 9 is a graph illustrating an amount of displacement of the slider with changes in Young's modulus of the elastic member. In this simulation, in the same manner as in the simulations illustrated in FIGS. 6 to 8, an amount of displacement of the slider is an amount of displacement at a point having the maximum amount of displacement of the slider.

It is assumed that the actuator used in the simulation is manufactured by the following methods.

(1) Material

As the piezoelectric material, PNN-PT-PZ ceramics is used.

As the electrode material, platinum (Pt) is used.

Alternatively, as the piezoelectric material, oxide ferroelectrics having the perovskite crystal structure such as lead zirconium titanate (PZT) can be used. Furthermore, as the electrode material, conductive metal such as gold (Au) can be used.

(2) Method for Manufacturing

a) A green sheet made of PNN-PT-PZ, on which a Pt electrode is screen-printed is prepared.

b) Then, a plurality of prepared green sheets are laminated.

c) Then, the laminated green sheets are fired in the atmosphere at a temperature of 1050° C.

d) Then, the obtained fired body is cut in the size of the piezoelectric device.

e) Then, the piezoelectric device cut into pieces, for example, like the piezoelectric actuators 30 and 40 illustrated in FIG. 5, is bonded to the elastic member prepared separately. At this time, for example, epoxy resin is used as a material of the elastic member.

As the material of the elastic member, any elastic materials other than epoxy resin can be used. However, from the viewpoint of enhancement of the strength of the piezoelectric device, for example, a material having a certain level of toughness is preferred.

As illustrated in FIG. 9, with increase in elastic modulus, an amount of displacement of the slider gradually increases. After reaching the maximum amount of displacement, the amount of displacement gradually decreases. Namely, if a large amount of displacement is to be obtained, it is necessary to use a material having the optimum Young's modulus as the elastic member. Materials capable of obtaining a large amount of displacement include a material made of epoxy resin. The Young's modulus of epoxy resin is about 2.4 GPa.

Furthermore, as can be seen from FIG. 9, when a material having the Young's modulus of 0.2 to 8.3 GPa is used as the elastic member, a large amount of displacement can be obtained as compared with the case where the elastic member is not used. In addition, to obtain a larger amount of displacement, it is preferable that a material having the Young's modulus of 0.4 to 5.0 GPa is used as the elastic member.

In this manner, according to the first embodiment, the piezoelectric actuators 30 and 40 arranged on the sides of the slider 5 cause the slider to undergo a rotational displacement. At this time, the slider 5 undergoes the rotational displacement about the gravity G, so that it is possible to prevent a change in position of the gravity of the slider 5 while the slider 5 undergoes the rotational displacement. Consequently, it is possible to prevent a disturbance with respect to the arm mechanism without increasing the thickness of the magnetic disk device, and also possible to achieve high-accuracy positioning of the magnetic head.

Furthermore, the piezoelectric actuators 30 and 40 are configured that the elastic members 35 and 45 having the predetermined Young's modulus are attached to the piezoelectric devices 33 and 43, respectively. As a result, the following two effects can be obtained.

1) The piezoelectric actuators 30 and 40 apply forces in a direction of rotating the slider 5 to the slider 5 efficiently.

2) The strengths of the piezoelectric devices 33 and 43 are enhanced by the elastic members 35 and 45, respectively.

### [b] Second Embodiment

A second embodiment of the piezoelectric actuator is described below. The portions identical to those in the first embodiment are denoted with the same reference numerals, and the description of those portions is omitted. FIG. 10 is a diagram illustrating an example of an actuator having a length shorter than that of the long side of the slider. As illustrated in FIG. 10, the piezoelectric actuators 30 and 40 have about half the length of the long side of the slider. The piezoelectric actuators 30 and 40 are arranged to be symmetrical about the gravity G of the slider 5.

By such configuration and arrangement, a direction of deformation of the piezoelectric actuators 30 and 40 can be reversed, so that it is possible to deform the slider 5 in various directions. To reverse the direction of deformation of the piezoelectric actuators 30 and 40 (to the direction opposite to that is in the first embodiment), a material resistant to polarization is used as the piezoelectric materials 31 and 41, and a voltage of an opposite polarity is just applied to the electrodes 32a and 32b and the electrodes 42a and 42b.

### [c] Third Embodiment

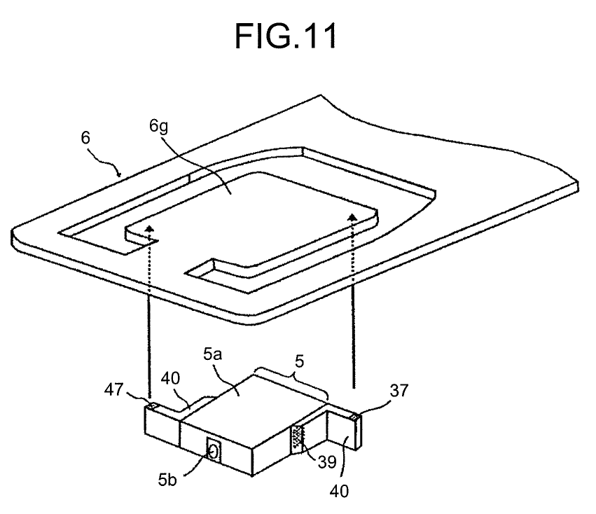

A third embodiment of the piezoelectric actuator is described below. FIG. 11 illustrates an example of an actuator whose end to be fixed to the suspension is provided at a position away from the slider 5. As illustrated in FIG. 11, the piezoelectric actuator 30 and 40 have an L-shape. Specifically, the ends 37 and 47 of the piezoelectric actuator 30 and 40 on the side to be fixed to the suspension 6 are elongated outwardly from the slider 5. In other words, the piezoelectric actuator 30 and 40 have a shape elongated outwardly from the slider 5 at the positions of the ends 37 and 47. The other configuration is identical to that is in the second embodiment.

By such configuration and arrangement, in the same manner as in the second embodiment, it is possible to deform the slider 5 in various directions. In addition, it is possible to obtain a larger amount of displacement of the magnetic head 5b.

It is possible to prevent a disturbance with respect to an arm mechanism without increasing the thickness of a magnetic disk device, and also possible to achieve high-accuracy positioning of a magnetic head.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic head support comprising:
a slider on which a magnetic head is mounted;
a suspension that supports the slider; and
a pair of piezoelectric actuators that are arranged on sides of the slider other than a side on which the magnetic head is mounted so as to be opposed to each other, wherein
the piezoelectric actuators are fixed to the suspension and the slider, and cause the slider to undergo a rotational displacement.

2. The magnetic head support according to claim 1, wherein each of the piezoelectric actuators includes a member having a long side, one end of the piezoelectric actuator is fixed to the side of the slider, and the other end is fixed to the suspension.

3. The magnetic head support according to claim 2, wherein the piezoelectric actuators apply a force in a direction of the long side to a portion fixed to the slider, and also apply a force in a direction perpendicular to the long side.

4. The magnetic head support according to claim 1, wherein the piezoelectric actuators are fixed to the slider so as to be symmetrical about a gravity of the slider.

5. The magnetic head support according to claim 1, wherein each of the piezoelectric actuators includes an elastic member and a piezoelectric device attached to the elastic member along a long side of the elastic member.

6. The magnetic head support according to claim 5, wherein Young's modulus of the elastic member is in a range of 0.2 GPa to 8.3 GPa.

7. The magnetic head support according to claim 5, wherein the elastic member is made of epoxy resin.

8. The magnetic head support according to claim 5, wherein the piezoelectric device is arranged on the side of the slider.

9. The magnetic head support according to claim 5, wherein the piezoelectric device includes a piezoelectric body made of a piezoelectric material and a pair of electrodes, the piezoelectric body being sandwiched between the electrodes.

10. The magnetic head support according to claim 9, wherein the piezoelectric device includes a plurality of active layers stacked, each layer including the piezoelectric body made of the piezoelectric material and a pair of the electrodes sandwiching the piezoelectric body therebetween.

11. The magnetic head support according to claim 9, wherein the piezoelectric material is PNN-PT-PZ ceramics.

12. The magnetic head support according to claim 1, wherein the piezoelectric actuators are arranged to be symmetrical about a gravity of the slider.

13. The magnetic head support according to claim 2, wherein the piezoelectric actuators have a shape elongated outwardly from the slider at a position of the other end thereof.

14. A magnetic head support comprising:
a slider on which a magnetic head is mounted;
a suspension that supports the slider; and
a pair of piezoelectric actuators that are arranged on sides of the slider other than a side opposed to the suspension, and cause the slider to undergo a rotational displacement.

15. A magnetic disk device comprising a magnetic head support on which a magnetic head is mounted, wherein
the magnetic head support includes
a slider on which the magnetic head is mounted;
a suspension that supports the slider; and
a pair of piezoelectric actuators that are arranged on sides of the slider other than a side on which the magnetic head is mounted so as to be opposed to each other, and
the piezoelectric actuators are fixed to the suspension and the slider, and cause the slider to undergo a rotational displacement.
